(19) United States
(12) Patent Application Publication
(10) Pub. No.: US 2023/0004325 A1
(43) Pub. Date: Jan. 5, 2023

(54) DATA PROCESSING SYSTEM AND OPERATING METHOD THEREOF

(71) Applicant: SK hynix Inc., Gyeonggi-do (KR)

(72) Inventor: Eu Joon BYUN, Gyeonggi-do (KR)

(21) Appl. No.: 17/673,283

(22) Filed: Feb. 16, 2022

(30) Foreign Application Priority Data
Jun. 30, 2021 (KR) 10-2021-0085878

(51) Int. Cl. G06F 3/06; G06F 12/02

(52) U.S. Cl. CPC G06F 3/0659; G06F 3/0647; G06F 3/0611; G06F 3/0679; G06F 12/0253

(57) ABSTRACT

A data processing system in which, in a case where it is difficult for a host to perform garbage collection by itself due to a load induced in the host in a system configured by Zoned Namespaces, the host requests garbage collection to a memory system and thus the memory system performs the garbage collection, and an operating method thereof.

### CROSS-REFERENCE TO RELATED APPLICATION

This application claims priority under 35 U.S.C. § 119 to Korean Patent Application No. 10-2021-0085878 filed on Jun. 30, 2021, which is incorporated herein by reference in its entirety.

### BACKGROUND

### 1. Field

Various embodiments relate to a data processing system and an operating method thereof, and more particularly, to a data processing system in which, in a case where it is difficult for a host to perform garbage collection by itself due to a load induced in the host in a system configured by Zoned Namespaces, the host requests garbage collection to a memory system and thus the memory system performs the garbage collection, and an operating method thereof.

### 2. Discussion of the Related Art

Recently, the paradigm for the computer environment has changed to ubiquitous computing in which computer systems can be used anytime and anywhere. Due to this fact, the use of portable electronic devices such as mobile phones, digital cameras, and notebook computers has rapidly increased. In general, such portable electronic devices use a memory system which uses a memory device, that is, a data storage device. The data storage device is used as a main memory device or an auxiliary memory device of the portable electronic devices.

A data storage device using a nonvolatile memory device provides advantages in that, since there is no mechanical driving part unlike a hard disk, stability and durability are excellent, an information access speed is high and power consumption is small. Data storage devices having such advantages include a universal serial bus (USB) memory device, memory cards having various interfaces, and a solid state drive (SSD).

### SUMMARY

Various embodiments of the present disclosure are directed to a data processing system in which, in a case where it is difficult for a host to perform garbage collection by itself due to a load induced in the host in a system configured by Zoned Namespaces, the host can entrust garbage collection to a memory system and thus the memory system can perform the garbage collection, and an operating method thereof.

Also, various embodiments of the present disclosure are directed to a data processing system capable of determining a load level of a host in order to decide whether to entrust garbage collection to a memory system, and an operating method thereof.

In an embodiment of the present disclosure, a data processing system may include: a host including a processor and a volatile memory and configured to sequentially allocate data to a plurality of zones of a Zoned Namespace; and a memory system including: a memory device including a plurality of memory blocks; and a controller configured to allocate the plurality of memory blocks to respective zones of the Zoned Namespace and access a memory block allocated for one of the plurality of zones according to an address of the zone inputted together with a data input/output request from the host, wherein the host is further configured to request garbage collection to the controller or perform host-based garbage collection, depending on a load level of the host.

In an embodiment of the present disclosure, a method for operating a data processing system may include: sequentially allocating, by a host including a processor and a volatile memory, data to a plurality of zones of a Zoned Namespace; allocating, by a controller, a plurality of memory blocks of a memory device to respective zones of the Zoned Namespace; accessing, by the controller, a memory block allocated for one zone among the plurality of zones according to an address of the zone inputted together with a data input/output request from the host; and requesting, by the host, garbage collection to the controller or performing host-based garbage collection, depending on a load level of the host.

In an embodiment of the present disclosure, a memory system may include: a memory device including a plurality of memory blocks; and a controller configured to: allocate the plurality of memory blocks to respective zones of a Zoned Namespace, access a memory block allocated for one of the plurality of zones according to an address of the zone inputted together with a data input/output request, and perform a garbage collection operation in response to a garbage collection request from a host.

In an embodiment of the present disclosure, an operating method of a data processing system, the operating method may include: requesting, by a host in a processor-bound status, a garbage collection operation by providing a controller with information for the operation; and controlling, by the controller, a memory device to perform the garbage collection operation on victim and target storage units included therein according to the information.

In the data processing system and the operating method thereof according to the embodiments of the present disclosure, in a case where it is difficult for a host to perform garbage collection by itself due to a load induced in the host in a system configured by Zoned Namespaces, the host can entrust garbage collection to a memory system and thus the memory system can perform the garbage collection.

Also, the data processing system and the operating method thereof according to the embodiments of the present disclosure can determine a load level of the host in order to decide whether to entrust garbage collection to the memory system.

### BRIEF DESCRIPTION OF THE DRAWINGS

FIG. 1 is a diagram schematically illustrating an example of a data processing system including a memory system in accordance with an embodiment of the present disclosure.

FIG. 2 is a diagram schematically illustrating an example of a memory device in accordance with an embodiment of the present disclosure.

FIG. 3 is a diagram schematically illustrating a memory cell array circuit of memory blocks in the memory device in accordance with an embodiment of the disclosure.

FIG. 4 is a diagram schematically illustrating the structure of the memory device in the memory system in accordance with an embodiment of the present disclosure.

FIG. 5 is a diagram schematically illustrating an example of a case where a plurality of command operations corresponding to a plurality of commands are performed in the memory system in accordance with an embodiment of the present disclosure.

FIG. 6 is a diagram illustrating the concept of a super memory block used in the memory system in accordance with an embodiment of the present disclosure.

FIG. 7 is a diagram illustrating a data processing system in accordance with an embodiment of the present disclosure in which Zoned Namespace technology is implemented.

FIG. 8 is a diagram illustrating a memory system including a nonvolatile memory device which supports Namespaces divided into the units of zones in accordance with an embodiment of the present disclosure.

FIG. 9 is a diagram illustrating a method for a host to perform garbage collection using Zoned Namespaces in accordance with an embodiment of the present disclosure.

FIG. 10 is a diagram illustrating a garbage collection method in the data processing system in accordance with an embodiment of the present disclosure to which the Zoned Namespace technology is applied.

FIG. 11 is a flowchart illustrating the garbage collection method in the data processing system in accordance with an embodiment of the present disclosure to which the Zoned Namespace technology is applied.

FIG. 12 is a flowchart illustrating a method for deciding a subject for performing garbage collection in accordance with an embodiment of the present disclosure.

FIG. 13 is a flowchart illustrating a method for deciding a subject for performing garbage collection in accordance with an embodiment of the present disclosure.

FIG. 14 is a flow diagram illustrating a process in accordance with an embodiment of the present disclosure in which the host transmits a garbage collection request to a controller of the memory system.

FIG. 15 is a diagram illustrating an example of a process of performing garbage collection requested to the memory system in accordance with an embodiment of the present disclosure.

### DETAILED DESCRIPTION

Various embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

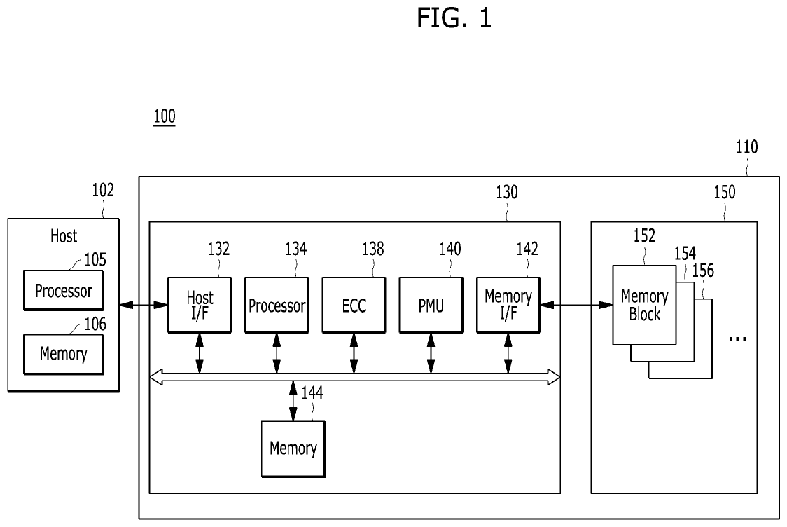

FIG. 1 is a diagram schematically illustrating an example of a data processing system including a memory system in accordance with an embodiment of the present disclosure.

Referring to FIG. 1, a data processing system 100 may include a host 102 and a memory system 110.

The host 102 includes electronic devices, for example, portable electronic devices such as a mobile phone, an MP3 player and a laptop computer or electronic devices such as a desktop computer, a game machine, a TV and a projector, that is, wired and wireless electronic devices.

The host 102 may include a processor 105 and a memory 106. The host 102 may include the processor 105 having higher performance and the memory 106 having larger capacity, as compared to the memory system 110 interworking with the host 102. Unlike the memory system 110, the processor 105 and the memory 106 in the host 102 provide advantages in that they have little space limitation and operate at high speed and the hardware upgrade of the processor 105 and the memory 106 is possible. In order to use the host 102 having higher performance as compared to the memory system 110, a Zoned Namespace system may be utilized and will be described later.

The host 102 includes at least one operating system (OS). The operating system generally manages and controls the function and operation of the host 102, and provides interoperability between the host 102 and a user using the data processing system 100 or the memory system 110. The operating system supports functions and operations corresponding to the user's purpose of use and the use of the operating system. For example, the operating system may be classified into a general operating system and a mobile operating system depending on the mobility of the host 102. Also, the general operating system as the operating system may be classified into a personal operating system and an enterprise operating system depending on the user's usage environment. For example, the personal operating system is a system characterized to support a service providing functions for a general user and may include windows and chrome, and the enterprise operating system is a system characterized to secure and support high performance and may include Windows server, Linux and Unix. In addition, the mobile operating system as the operating system is a system characterized to support a mobility service providing function and a system power saving function to users and may include Android, iOS, Windows mobile, etc. The host 102 may include a plurality of operating systems, and executes the operating systems to perform operations with the memory system 110 in response to a user request. The host 102 transmits a plurality of commands corresponding to a user request to the memory system 110, and accordingly, the memory system 110 performs operations corresponding to the commands, that is, operations corresponding to the user request.

The memory system 110 operates in response to a request of the host 102, and particularly, stores data to be accessed by the host 102. The memory system 110 may be used as a main memory device or an auxiliary memory device of the host 102. The memory system 110 may be implemented as any of various storage devices, depending on a host interface protocol which is coupled with the host 102. For example, the memory system 110 may be implemented into any of various storage devices such as a solid state drive (SSD), a multimedia card in the form of an MMC, an eMMC (embedded MMC), an RS-MMC (reduced size MMC) and a micro-MMC, a secure digital card in the form of an SD, a mini-SD and a micro-SD, a universal serial bus (USB) storage device, a universal flash storage (UFS) device, a compact flash (CF) card, a smart media card, a memory stick, and so forth.

The storage devices which implement the memory system 110 may be implemented by a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), an ferroelectric random access memory (FRAM), a phase change RAM (PRAM), a magnetic RAM (MRAM), a resistive RAM (RRAM) and a flash memory.

The memory system 110 includes a memory device 150 which stores data to be accessed by the host 102, and a controller 130 which controls storage of data in the memory device 150.

The controller 130 and the memory device 150 may be integrated into one semiconductor device. For instance, the controller 130 and the memory device 150 may be integrated into one semiconductor device and thereby configure an SSD. In the case where the memory system 110 is used as an SSD, the operating speed of the host 102 which is coupled to the memory system 110 may be improved. Further, the controller 130 and the memory device 150 may be integrated into one semiconductor device and configure a memory card.

For example, the controller 130 and the memory device 150 may configure a memory card such as a PC card (PCMCIA: Personal Computer Memory Card International Association), a compact flash card (CF), a smart media card (SM and SMC), a memory stick, a multimedia card (MMC, RS-MMC and MMCmicro), an SD card (SD, miniSD, microSD and SDHC) and a universal flash storage (UFS).

For another instance, the memory system 110 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID (radio frequency identification) device, or one of various component elements configuring a computing system.

The memory device 150 in the memory system 110 may maintain stored data even though power is not supplied. In particular, the memory device 150 in the memory system 110 stores data provided from the host 102, through a write operation, and provides stored data to the host 102, through a read operation. The memory device 150 includes a plurality of memory blocks 152, 154 and 156. Each of the memory blocks 152, 154 and 156 includes a plurality of pages. Each of the pages includes a plurality of memory cells to which a plurality of word lines (WL) are coupled. Also, the memory device 150 includes a plurality of planes each of which includes the plurality of memory blocks 152, 154 and 156. In particular, the memory device 150 may include a plurality of memory dies each of which includes a plurality of planes. The memory device 150 may be a nonvolatile memory device, for example, a flash memory, and the flash memory may have a 3D stack structure.

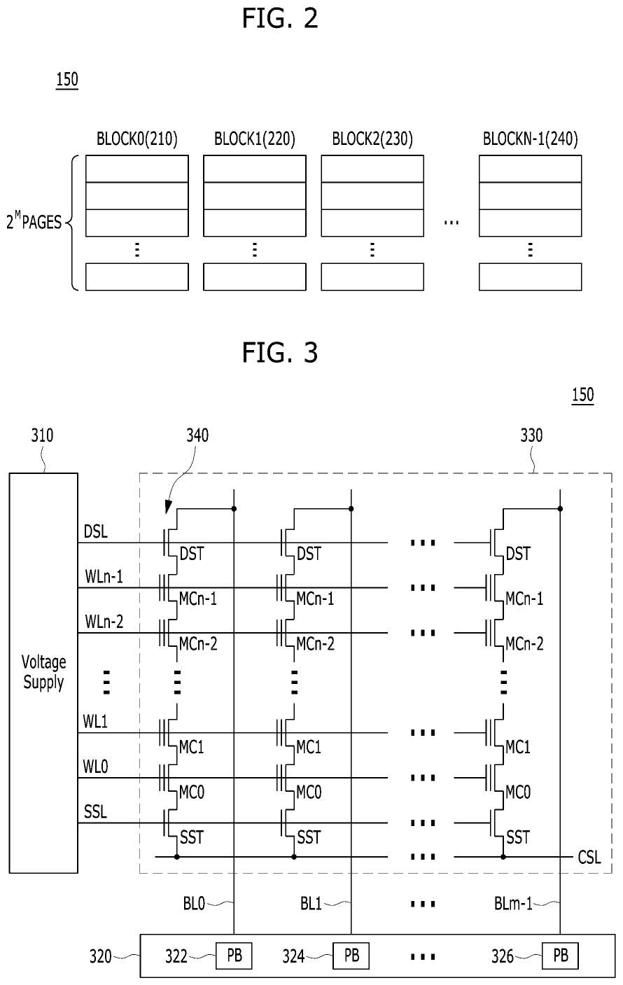

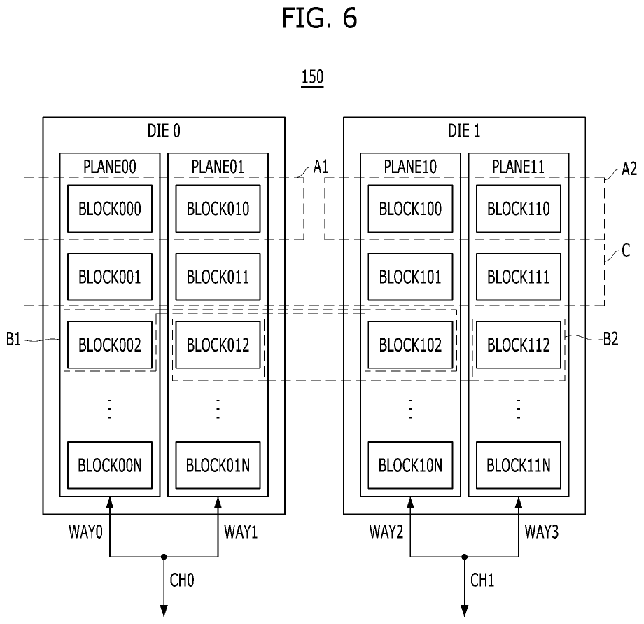

Since detailed descriptions will be made below with reference to FIGS. 2 to 4 for the structure of the memory device 150 and the 3-dimensional stack structure of the memory device 150 and detailed descriptions will be made below with reference to FIG. 6 for a plurality of planes each including the plurality of memory blocks 152, 154 and 156, a plurality of memory dies each including a plurality of planes and the memory device 150 including the plurality of memory dies, further descriptions thereof will be omitted herein.

The controller 130 in the memory system 110 controls the memory device 150 in response to a request from the host 102. For example, the controller 130 provides the data read from the memory device 150, to the host 102, and stores the data provided from the host 102, in the memory device 150. To this end, the controller 130 controls the operations of the memory device 150, such as read, write, program, and erase operations.

In detail, the controller 130 includes a host interface unit (Host I/F) 132, a processor (Processor) 134, an error correction code unit (ECC) 138, a power management unit (PMU) 140, a memory interface unit (Memory I/F) 142 and a memory 144.

The host interface unit 132 processes the commands and data of the host 102, and may be configured to communicate with the host 102 through at least one of various communication standards or interfaces such as universal serial bus (USB), multimedia card (MMC), peripheral component interconnect-express (PCI-e or PCIe), serial attached SCSI (SAS), serial advanced technology attachment (SATA), parallel advanced technology attachment (PATA), small computer system interface (SCSI), enhanced small disk interface (ESDI), integrated drive electronics (IDE) and MIPI (mobile industry processor interface). The host interface unit 32 may be driven through firmware which is referred to as a host interface layer (HIL), and is a region which exchanges data with the host 102.

The ECC unit 138 may correct an error bit of the data processed in the memory device 150, and may include an ECC encoder and an ECC decoder. The ECC encoder may error correct-encode data to be programmed in the memory device 150 and generate data added with parity bits. The data added with parity bits may be stored in the memory device 150. The ECC decoder detects and corrects an error included in data read from the memory device 150, in the case of reading data stored in the memory device 150. That is, after performing error correction decoding for data read from the memory device 150, the ECC unit 138 may determine whether the error correction decoding has succeeded, may output an indication signal depending on a determination result, for example, an error correction success/failure signal, and may correct an error bit of the read data by using the parity bits generated in the ECC encoding process. The ECC unit 138 cannot correct error bits when the number of occurred error bits is equal to or greater than a correctable error bit limit, and may output an error correction failure signal corresponding to the incapability of correcting error bits.

The ECC unit 138 may perform error correction by using, but not limited to, an LDPC (low density parity check) code, a BCH (Bose, Chaudhuri, Hocquenghem) code, a turbo code, a Reed-Solomon code, a convolution code, an RSC (recursive systematic code), or a coded modulation such as a TCM (trellis-coded modulation) or a BCM (block coded modulation). The ECC unit 138 may include a circuit, a module, a system or a device for error correction.

The PMU 140 provides and manages power for the controller 130, that is, power for the components included in the controller 130.

The memory interface unit 142 serves as a memory/storage interface which performs interfacing between the controller 130 and the memory device 150, to allow the controller 130 to control the memory device 150 in response to a request from the host 102. The memory interface unit 142 generates control signals for the memory device 150 and processes data according to the control of the processor 134, as a NAND flash controller (NFC) in the case where the memory device 150 is a flash memory, in particular, in the case where the memory device 150 is a NAND flash memory. The memory interface unit 142 may support the operation of an interface which processes a command and data between the controller 130 and the memory device 150, for example, a NAND flash interface, in particular, data input/output between the controller 130 and the memory device 150, and may be driven through a firmware referred to as a flash interface layer (FIL) being a region which exchanges data with the memory device 150.

The memory 144, as the working memory of the memory system 110 and the controller 130, stores data for driving of the memory system 110 and the controller 130. In detail, in the case where the controller 130 controls the memory device 150 in response to a request from the host 102, for example, in the case where the controller 130 provides the data read from the memory device 150, to the host 102, and stores the data provided from the host 102, in the memory device 150, and, to this end, in the case where the controller 130 controls the operations of the memory device 150, such as read, write, program and erase operations, the memory 144 stores data needed to allow such operations to be performed by the memory system 110, that is, between the controller 130 and the memory device 150.

The memory 144 may be implemented by a volatile memory. For example, the memory 1441 may be implemented by a static random access memory (SRAM) or a dynamic random access memory (DRAM). Furthermore, the memory 144 may exist inside the controller 130 as illustrated in FIG. 1. Alternatively, the memory 144 may exist outside the controller 130, and in this regard, may be implemented as an external volatile memory to and from which data are inputted and outputted from and to the controller 130 through a memory interface.

As described above, the memory 144 stores data needed to perform data read and write operations between the host 102 and the memory device 150 and data when performing the data read and write operations. For such data storage, the memory 144 includes a program memory, a data memory, a write buffer/cache, a read buffer/cache, a data buffer/cache, a map buffer/cache, and so forth.

The processor 134 controls the general operations of the memory system 110, and particularly, controls a program operation or a read operation for the memory device 150, in response to a write request or a read request from the host 102. The processor 134 drives a firmware which is referred to as a flash translation layer (FTL), to control general operations of the memory system 110. The processor 134 may be implemented by a microprocessor or a central processing unit (CPU).

For instance, the controller 130 performs an operation requested from the host 102, in the memory device 150, that is, performs a command operation corresponding to a command received from the host 102, with the memory device 150, through the processor 134 implemented by a microprocessor or a central processing unit (CPU). The controller 130 may perform a foreground operation as a command operation corresponding to a command received from the host 102, for example, a program operation corresponding to a write command, a read operation corresponding to a read command, an erase operation corresponding to an erase command or a parameter set operation corresponding to a set parameter command or a set feature command as a set command.

The controller 130 may also perform a background operation for the memory device 150, through the processor 134 implemented by a microprocessor or a central processing unit (CPU). The background operation for the memory device 150 includes an operation of copying the data stored in a certain memory block among the memory blocks 152, 154 and 156 of the memory device 150, to another certain memory block, for example, a garbage collection (GC) operation, an operation of swapping the memory blocks 152, 154 and 156 of the memory device 150 or the data stored in the memory blocks 152, 154 and 156, for example, a wear leveling (WL) operation, an operation of storing the map data stored in the controller 130, in the memory blocks 152, 154 and 156 of the memory device 150, for example, a map flush operation, or an operation of performing bad block management for the memory device 150, for example, a bad block management operation of checking and processing a bad block in the plurality of memory blocks 152, 154 and 156 included in the memory device 150.

Also, in a memory system in accordance with an embodiment of the present disclosure, for instance, in the case where the controller 130 performs a plurality of command operations corresponding to a plurality of commands received from the host 102, for example, a plurality of program operations corresponding to a plurality of write commands, a plurality of read operations corresponding to a plurality of read commands and a plurality of erase operations corresponding to a plurality of erase commands, in the memory device 150, best channels (or ways) are decided among a plurality of channels (or ways) coupled with a plurality of memory dies included in the memory device 150, the commands received from the host 102 are transmitted to corresponding memory dies through the best channels (or ways), performance results of the command operations are received through the best channels (or ways) from the memory dies in which the command operations corresponding to the commands are performed, and the performance results of the command operations are provided to the host 102. In particular, in the memory system in accordance with an embodiment of the present disclosure, in the case where a plurality of commands are received from the host 102, after checking the states of a plurality of channels (or ways) coupled with the memory dies of the memory device 150, best transmission channels (or transmission ways) are decided which correspond to the states of the channels (or ways), and the plurality of commands received from the host 102 are transmitted to corresponding memory dies through the best transmission channels (or transmission ways). Moreover, in the memory system in accordance with an embodiment of the present disclosure, after performing command operations corresponding to the plurality of commands received from the host 102, in the memory dies of the memory device 150, performance results of the command operations are received from the memory dies of the memory device 150 through best reception channels (or reception ways) corresponding to the states of channels (or ways) among the plurality of channels (or ways) coupled with the memory dies of the memory device 150. The performance results received from the memory dies of the memory device 150 are provided to the host 102 as responses to the plurality of commands received from the host 102.

After checking the states of the plurality of channels (or ways) coupled with the plurality of memory dies included in the memory device 150, for example, a busy state, a ready state, an active state, an idle state, a normal state or an abnormal state of the channels (or ways), the controller 130 transmits the plurality of commands received from the host 102, to the corresponding memory dies through the best channels (or ways) according to the states of the channels (or ways), that is, requests performing of the command operations corresponding to the plurality of commands received from the host 102, to the corresponding memory dies through the best transmission channels (or transmission ways). In response to the request for performing of the command operations through the best transmission channels (or transmission ways), the controller 130 receives the performance results of the command operations from the corresponding memory dies. In this regard, the controller 130 receives the performance results of the command operations through the best channels (or ways) according to the states of the channels (or ways), that is, the best reception channels (or reception ways). The controller 130 matches the descriptors of the commands transmitted through the best transmission channels (or transmission ways) and the descriptors of the performance results received through the best reception channels (or reception ways), and then, provides the performance results of the command operations corresponding to the commands received from the host 102, to the host 102.

In the descriptors of the commands, there may be included data information or position information corresponding to the commands, for example, the addresses of data corresponding to write commands or read commands (for instance, logical page numbers of data) or the addresses of positions where data are stored (for instance, the physical page information of the memory device 150), etc. and indication information of transmission channels (or transmission ways) through which the commands are transmitted, for example, the identifiers (for example, channel numbers (or way numbers)) of the transmission channels (or the transmission ways), etc. In the descriptors of the performance results, there may be included data information or position information corresponding to the performance results, for example, the addresses for the data of program operations corresponding to write commands or the data of read operations corresponding to read commands (for instance, logical page numbers for data) or the addresses of positions where the program operations or the read operations are performed (for instance, the physical page information of the memory device 150), etc. and indication information of channels (or ways) through which command operations are requested, that is, transmission channels (or transmission ways) through which the commands are transmitted, for example, the identifiers (for example, channel numbers (or way numbers)) of the transmission channels (or the transmission ways), etc. The information included in the descriptors of the commands and the descriptors of the performance results, for example, the data information, the position information or the indication information of the channels (or the ways), may be included in the descriptors in the form of contexts or tags.

That is, in the memory system 110 in accordance with an embodiment of the present disclosure, the plurality of commands received from the host 102 and the performance results of the plurality of command operations corresponding to the commands are transmitted and received through the best channels (or ways) among the plurality of channels (or ways) coupled with the memory dies of the memory device 150. In particular, in the memory system 110 in accordance with an embodiment of the present disclosure, in correspondence to the states of the plurality of channels (or ways) coupled with the memory dies of the memory device 150, the transmission channels (or transmission ways) through which the commands are to be transmitted to the memory dies of the memory device 150 and the reception channels (or reception ways) through which the performance results of the command operations are to be received from the memory dies of the memory device 150 are managed independently of each other. For example, the controller 130 in the memory system 110 decides a transmission channel (or transmission way) through which a first command is transmitted and a reception channel (or reception way) through which a performance result of a first command operation corresponding to the first command is received, as best channels (or ways) which are independent of each other, among the plurality of channels (or ways), in correspondence to the states of the plurality of channels (or ways). For instance, the transmission channel (or transmission way) is decided as a first best channel (or way) and the reception channel (or reception way) is decided as the first best channel (or way) or a second best channel (or way), and then, transmission of the first command and reception of the performance result of the first command operation are respectively performed through the best channels (or ways) which are independent of each other.

Therefore, in the memory system 110 in accordance with an embodiment of the present disclosure, the plurality of channels (or ways) coupled with the plurality of memory dies of the memory device 150 may be used efficiently. In particular, since the plurality of commands received from the host 102 and the performance results of the command operations corresponding to the commands are respectively transmitted and received through the best channels (or ways) which are independent of each other, the operational performance of the memory system 110 may be improved. While it will be described as an example in an embodiment of the present disclosure for the sake of convenience in description that the plurality of commands received from the host 102 and the performance results of the command operations corresponding to the commands are transmitted and received through the plurality of channels (or ways) for the memory dies included in the memory device 150 of the memory system 110, it is to be noted that the same principle may be applied even in the case where, in a plurality of memory systems each including the controller 130 and the memory device 150, a plurality of commands received from the host 102 and performance results after performing command operations corresponding to the commands in the respective memory systems are transmitted and received through a plurality of channels (or ways) for the respective memory systems.

Hereinbelow, a memory device in the memory system in accordance with an embodiment of the present disclosure will be described in detail with reference to FIGS. 2 to 4.

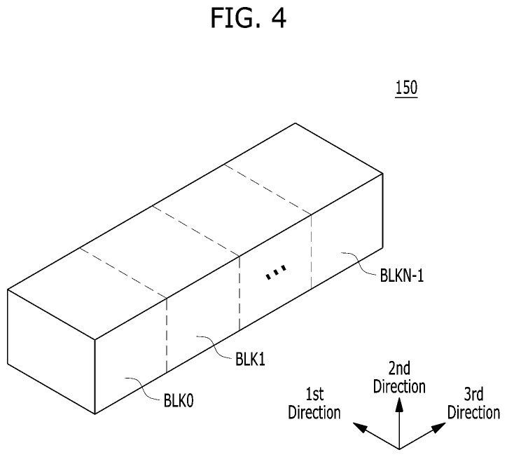

FIG. 2 is a diagram schematically illustrating an example of a memory device in accordance with an embodiment of the present disclosure, FIG. 3 is a diagram schematically illustrating a memory cell array circuit of memory blocks in the memory device in accordance with an embodiment of the present disclosure, and FIG. 4 is a diagram schematically illustrating the structure of the memory device in the memory system in accordance with an embodiment of the present disclosure. FIG. 4 is a diagram schematically illustrating a structure in the case where the memory device is implemented as a 3-dimensional nonvolatile memory device.

First, referring to FIG. 2, the memory device 150 includes a plurality of memory blocks, for example, a zeroth block (BLOCK0) 210, a first block (BLOCK1) 220, a second block (BLOCK2) 230 and an (N−1)th block (BLOCKN−1) 240. Each of the blocks 210, 220, 230 and 240 includes a plurality of pages, for example, 2^{M} number of pages (2^{M} PAGES). While it is described for the sake of convenience in description that each of the plurality of memory blocks includes 2^{M} number of pages, it is to be noted that each of the plurality of memory blocks may include M number of pages. Each of the pages includes a plurality of memory cells to which a plurality of word lines (WL) are coupled.

Also, depending on the number of bits capable of storing or expressing the plurality of memory blocks in one memory cell, the memory device 150 may include a single level cell (SLC) memory block including a plurality of pages implemented by memory cells each storing 1-bit data, a multi-level cell (MLC) memory block including a plurality of pages implemented by memory cells each capable of storing 2-bit data, a triple level cell (TLC) memory block including a plurality of pages implemented by memory cells each capable of storing 3-bit data, a quadruple level cell (QLC) memory block including a plurality of pages implemented by memory cells each capable of storing 4-bit data, a multiple level cell memory block including a plurality of pages implemented by memory cells each capable of storing 5 or more-bit data, or the like.

The memory device 150 may store a larger amount of data in the multiple level cell memory block than in the single level cell memory block. However, the memory device 150 may more quickly process data by using the single level cell memory block than by using the multiple level cell memory block. That is, the single level cell memory block and the multiple level cell memory block have different advantages and disadvantages from each other. Because of this fact, when rapid data processing is required, the processor 134 may control the memory device 150 such that the memory device 150 programs data to the single level cell memory block. On the other hand, when a large amount of storage space is required, the processor 134 may control the memory device 150 such that the memory device 150 programs data to the multiple level cell memory block. As a result, according to a situation, the processor 134 may decide the type of a memory block in which data is to be stored.

While it is described below as an example for the sake of convenience in description that the memory device 150 is implemented by a nonvolatile memory such as a flash memory, for example, a NAND flash memory, it is to be noted that the memory device 150 may be implemented as any memory among memories such as a phase change memory or phase change random access memory (PCRAM), a resistive memory or resistive random access memory (RRAM or ReRAM), a ferroelectric memory or ferroelectric random access memory (FRAM) and a spin transfer torque magnetic memory or spin transfer torque magnetic random access memory (SU-RAM or STT-MRAM).

Each of the memory blocks 210, 220, 230 and 240 stores the data provided from the host device 102, through a program operation, and provides stored data to the host 102, through a read operation.

Referring to FIG. 3, a plurality of memory blocks included in the memory device 150 of the memory system 110 may be implemented as a memory cell array 330, and thereby, may include a plurality of cell strings 340 which are coupled to bit lines BL0 to BLm−1, respectively. The cell string 340 of each column may include at least one drain select transistor DST and at least one source select transistor SST. A plurality of memory cells or memory cell transistors MC0 to MCn−1 may be coupled in series between the select transistors DST and SST. The respective memory cells MC0 to MCn−1 may be configured by multi-level cells (MLC) each of which stores data information of a plurality of bits. The cell strings 340 may be electrically coupled to the corresponding bit lines BL0 to BLm−1, respectively.

While FIG. 3 illustrates, as an example, each memory cell array 330 which is configured by NAND flash memory cells, it is to be noted that the plurality of memory blocks included in the memory device 150 in accordance with an embodiment of the present disclosure are not limited to a NAND flash memory and may be implemented by a NOR flash memory, a hybrid flash memory in which at least two types of memory cells are combined or a one-NAND flash memory in which a controller is built into a memory chip.

A voltage supply 310 of the memory device 150 may provide word line voltages (for example, a program voltage, a read voltage and a pass voltage) to be supplied to respective word lines depending on an operation mode and a voltage to be supplied to a bulk (for example, a well region) where memory cells are formed. The voltage generating operation of the voltage supply 310 may be performed under the control of a control circuit (not illustrated). The voltage supply 310 may generate a plurality of variable read voltages to generate a plurality of read data, select one among the memory blocks (or sectors) of a memory cell array in response to the control of the control circuit, select one among the word lines of the selected memory block, and provide word line voltages to the selected word line and unselected word lines.

A read/write circuit 320 of the memory device 150 is controlled by the control circuit, and may operate as a sense amplifier or a write driver according to an operation mode. For example, in the case of a verify/normal read operation, the read/write circuit 320 may operate as a sense amplifier for reading data from the memory cell array. Also, in the case of a program operation, the read/write circuit 320 may operate as a write driver which drives bit lines according to data to be stored in the memory cell array. In the program operation, the read/write circuit 320 may receive data to be written in the memory cell array, from a buffer (not illustrated), and may drive the bit lines according to inputted data. To this end, the read/write circuit 320 may include a plurality of page buffers (PB) 322, 324 and 326 respectively corresponding to columns (or bit lines) or pairs of columns (or pairs of bit lines), and a plurality of latches (not illustrated) may be included in each of the page buffers 322, 324 and 326.

Also, the memory device 150 may be implemented as a two-dimensional or three-dimensional memory device. In particular, as illustrated in FIG. 4, the memory device 150 may be implemented as a nonvolatile memory device with a three-dimensional stack structure. In the case where the memory device 150 is implemented as a three-dimensional structure, the memory device 150 may include a plurality of memory blocks BLK0 to BLKN−1. FIG. 4 is a block diagram illustrating the memory blocks of the memory device 150 illustrated in FIG. 1, and each of the memory blocks may be implemented as a three-dimensional structure (or a vertical structure). For example, the respective memory blocks may be implemented as a three-dimensional structure by including a structure which extends in first to third directions, for example, an x-axis direction, a y-axis direction and a z-axis direction.

Each memory cell array 330 included in the memory device 150 may include a plurality of NAND strings NS which extend in the second direction. The plurality of NAND strings NS may be provided in the first direction and the third direction. Each NAND string NS may be coupled to a bit line BL, at least one string select line SSL, at least one ground select line GSL, a plurality of word lines WL, at least one dummy word line DWL and a common source line CSL, and may include a plurality of transistor structures TS.

Namely, among the plurality of memory blocks of the memory device 150, each memory cell array 330 may be coupled to a plurality of bit lines BL, a plurality of string select lines SSL, a plurality of ground select lines GSL, a plurality of word lines WL, a plurality of dummy word lines DWL and a plurality of common source lines CSL, and accordingly, may include a plurality of NAND strings NS. Also, in each memory cell array 330, a plurality of NAND strings NS may be coupled to one bit line BL, and thereby, a plurality of transistors may be implemented in one NAND string NS. The string select transistor SST of each NAND string NS may be coupled with a corresponding bit line BL, and the ground select transistor GST of each NAND string NS may be coupled with the common source line CSL. Memory cells MC may be provided between the string select transistor SST and the ground select transistor GST of each NAND string NS. Namely, in each memory cell array 330 of the plurality of memory blocks of the memory device 150, a plurality of memory cells may be implemented.

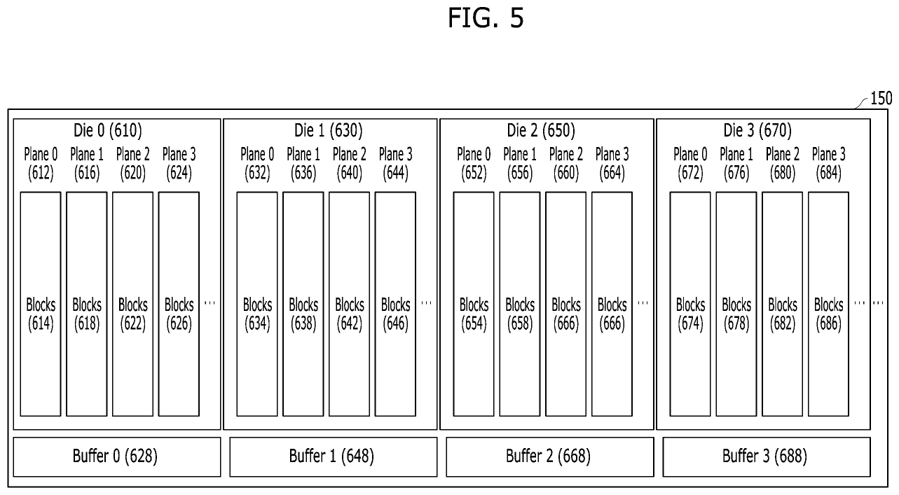

FIG. 5 is a diagram schematically illustrating an example of a case where a plurality of command operations corresponding to a plurality of commands are performed in the memory system in accordance with an embodiment of the present disclosure.

Referring to FIG. 5, the memory device 150 includes a plurality of memory dies, for example, a memory die 0 610, a memory die 1 630, a memory die 2 650 and a memory die 3 670. Each of the memory dies 610, 630, 650 and 670 includes a plurality of planes. For example, the memory die 0 610 includes a plane 0 612, a plane 1 616, a plane 2 620 and a plane 3 624, the memory die 1 630 includes a plane 0 632, a plane 1 636, a plane 2 640 and a plane 3 644, the memory die 2 650 includes a plane 0 652, a plane 1 656, a plane 2 660 and a plane 3 664, and the memory die 3 670 includes a plane 0 672, a plane 1 676, a plane 2 680 and a plane 3 684. The respective planes 612, 616, 620, 624, 632, 636, 640, 644, 652, 656, 660, 664, 672, 676, 680 and 684 in the memory dies 610, 630, 650 and 670 included in the memory device 150 include a plurality of memory blocks 614, 618, 622, 626, 634, 638, 642, 646, 654, 658, 662, 666, 674, 678, 682 and 686, for example, N number of blocks Block0, Block1, . . . and BlockN−1 each including a plurality of pages, for example, 2^{M} number of pages, as described above with reference to FIG. 2. Moreover, the memory device 150 includes a plurality of buffers corresponding to the respective memory dies 610, 630, 650 and 670, for example, a buffer 0 628 corresponding to the memory die 0 610, a buffer 1 648 corresponding to the memory die 1 630, a buffer 2 668 corresponding to the memory die 2 650, and a buffer 3 688 corresponding to the memory die 3 670.

In the case of performing command operations corresponding to a plurality of commands received from the host 102, data corresponding to the command operations are stored in the buffers 628, 648, 668 and 688 included in the memory device 150. For example, in the case of performing program operations, data corresponding to the program operations are stored in the buffers 628, 648, 668 and 688, and are then stored in the pages included in the memory blocks of the memory dies 610, 630, 650 and 670. In the case of performing read operations, data corresponding to the read operations are read from the pages included in the memory blocks of the memory dies 610, 630, 650 and 670, are stored in the buffers 628, 648, 668 and 688, and are then provided to the host 102 through the controller 130.

In an embodiment of the present disclosure, while it will be described below as an example for the sake of convenience in description that the buffers 628, 648, 668 and 688 included in the memory device 150 exist outside the respective corresponding memory dies 610, 630, 650 and 670, it is to be noted that the buffers 628, 648, 668 and 688 may exist inside the respective corresponding memory dies 610, 630, 650 and 670, and it is to be noted that the buffers 628, 648, 668 and 688 may correspond to the respective planes 612, 616, 620, 624, 632, 636, 640, 644, 652, 656, 660, 664, 672, 676, 680 and 684 or the respective memory blocks 614, 618, 622, 626, 634, 638, 642, 646, 654, 658, 662, 666, 674, 678, 682 and 686 in the respective memory dies 610, 630, 650 and 670. Further, in an embodiment of the present disclosure, while it will be described below as an example for the sake of convenience in description that the buffers 628, 648, 668 and 688 included in the memory device 150 are the plurality of page buffers 322, 324 and 326 included in the memory device 150 as described above with reference to FIG. 3, it is to be noted that the buffers 628, 648, 668 and 688 may be a plurality of caches or a plurality of registers included in the memory device 150.

FIG. 6 is a diagram illustrating the concept of a super memory block used in the memory system in accordance with an embodiment of the present disclosure.

Referring to FIG. 6, it may be seen that the components included in the memory device 150 among the components of the memory system 110 in accordance with the embodiment illustrated in FIG. 1 are illustrated in detail.

The memory device 150 includes a plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N.

The memory device 150 includes a zeroth memory die DIE0 capable of inputting/outputting data through a zeroth channel CH0 and a first memory die DIE1 capable of inputting/outputting data through a first channel CH1. The zeroth channel CH0 and the first channel CH1 may input/output data in an interleaving scheme.

The zeroth memory die DIE0 includes a plurality of planes PLANE00 and PLANE01 respectively corresponding to a plurality of ways WAY0 and WAY1 capable of inputting/outputting data in the interleaving scheme by sharing the zeroth channel CH0.

The first memory die DIE1 includes a plurality of planes PLANE10 and PLANE11 respectively corresponding to a plurality of ways WAY2 and WAY3 capable of inputting/outputting data in the interleaving scheme by sharing the first channel CH1.

The first plane PLANE00 of the zeroth memory die DIE0 includes a predetermined number of memory blocks BLOCK000, BLOCK001, BLOCK002, . . . and BLOCK00N among the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N.

The second plane PLANE01 of the zeroth memory die DIE0 includes the predetermined number of memory blocks BLOCK010, BLOCK011, BLOCK012, . . . and BLOCK01N among the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N.

The first plane PLANE10 of the first memory die DIE1 includes the predetermined number of memory blocks BLOCK100, BLOCK101, BLOCK102, . . . and BLOCK10N among the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N.

The second plane PLANE11 of the first memory die DIE1 includes the predetermined number of memory blocks BLOCK110, BLOCK111, BLOCK112, . . . and BLOCK11N among the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N.

In this manner, the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N included in the memory device 150 may be divided according to physical positions such as using the same ways or the same channels.

For reference, while it is illustrated in FIG. 6 that two memory dies DIE0 and DIE1 are included in the memory device 150, two planes PLANE00 and PLANE01/PLANE10 and PLAN Eli are included in each of the memory dies DIE0 and DIE1 and a predetermined number of memory blocks BLOCK000, BLOCK001, BLOCK002, . . . and BLOCK00N/BLOCK010, BLOCK011, BLOCK012, . . . and BLOCK01N/BLOCK100, BLOCK101, BLOCK102, . . . and BLOCK10N/BLOCK110, BLOCK111, BLOCK112, . . . and BLOCK11N are included in each of the planes PLANE00, PLANE01, PLANE10 and PLANE11, it is to be noted that this is an example. According to a designer's choice, a number of memory dies that is larger or smaller than two may be included in the memory device 150, and a number of planes that is larger or smaller than two may be included in each memory die. Of course, the predetermined number as the number of memory blocks included in each plane may be adjusted variously according to a designer's choice.

Moreover, different from the scheme of dividing the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N included in the memory device 150 according to physical positions such as the plurality of memory dies DIE0 and DIE1 or the plurality of planes PLANE00, PLANE01, PLANE10 and PLANE11, the controller 130 may use a scheme of dividing a plurality of memory blocks according to simultaneous selection and operation of memory blocks. That is, the controller 130 may manage a plurality of memory blocks which are divided into different dies or different planes through the dividing scheme according to physical positions, by grouping memory blocks capable of being simultaneously selected among the plurality of memory blocks and thereby dividing the plurality of memory blocks into super memory blocks. In this regard, ‘being simultaneously selected’ may mean ‘being selected in parallel.’

The scheme of grouping, in this manner, the plurality of memory blocks BLOCK000, BLOCK001, BLOCK002, . . . and BLOCK00N, BLOCK010, BLOCK011, BLOCK012, . . . and BLOCK01N, BLOCK100, BLOCK101, BLOCK102, . . . and BLOCK10N, and BLOCK110, BLOCK111, BLOCK112, . . . and BLOCK11N into super memory blocks by the controller 130 may be divided into various schemes according to a designer's choice, and three schemes will be described herein.

A first scheme is to manage one super memory block A1 by grouping, by the controller 130, one optional memory block BLOCK000 in the first plane PLANE00 and one optional memory block BLOCK010 in the second plane PLANE01 of the zeroth memory die DIE0 between the plurality of memory dies DIE0 and DIE1 included in the memory device 150. When applying the first scheme to the first memory die DIE1 between the plurality of memory dies DIE0 and DIE1 included in the memory device 150, the controller 130 may manage one super memory block A2 by grouping one optional memory block BLOCK100 in the first plane PLANE10 and one optional memory block BLOCK110 in the second plane PLANE11 of the first memory die DIE1.

A second scheme is to manage one super memory block B1 by grouping, by the controller 130, one optional memory block BLOCK002 included in the first plane PLANE00 of the zeroth memory die DIE0 between the plurality of memory dies DIE0 and DIE1 included in the memory device 150 and one optional memory block BLOCK102 included in the first plane PLANE10 of the first memory die DIE1. When applying the second scheme again, the controller 130 may manage one super memory block B2 by grouping one optional memory block BLOCK012 included in the second plane PLANE01 of the zeroth memory die DIE0 between the plurality of memory dies DIE0 and DIE1 included in the memory device 150 and one optional memory block BLOCK112 included in the second plane PLANE11 of the first memory die DIE1.

A third scheme is to manage one super memory block C by grouping, by the controller 130, one optional memory block BLOCK001 included in the first plane PLANE00 of the zeroth memory die DIE0 between the plurality of memory dies DIE0 and DIE1 included in the memory device 150, one optional memory block BLOCK011 included in the second plane PLANE01 of the zeroth memory die DIE0, one optional memory block BLOCK101 included in the first plane PLANE10 of the first memory die DIE1 and one optional memory block BLOCK111 included in the second plane PLANE11 of the first memory die DIE1.

For reference, memory blocks capable of being simultaneously selected by being included in a super memory block may be substantially simultaneously selected through an interleaving scheme, for example, a channel interleaving scheme, a memory die interleaving scheme, a memory chip interleaving scheme or a way interleaving scheme.

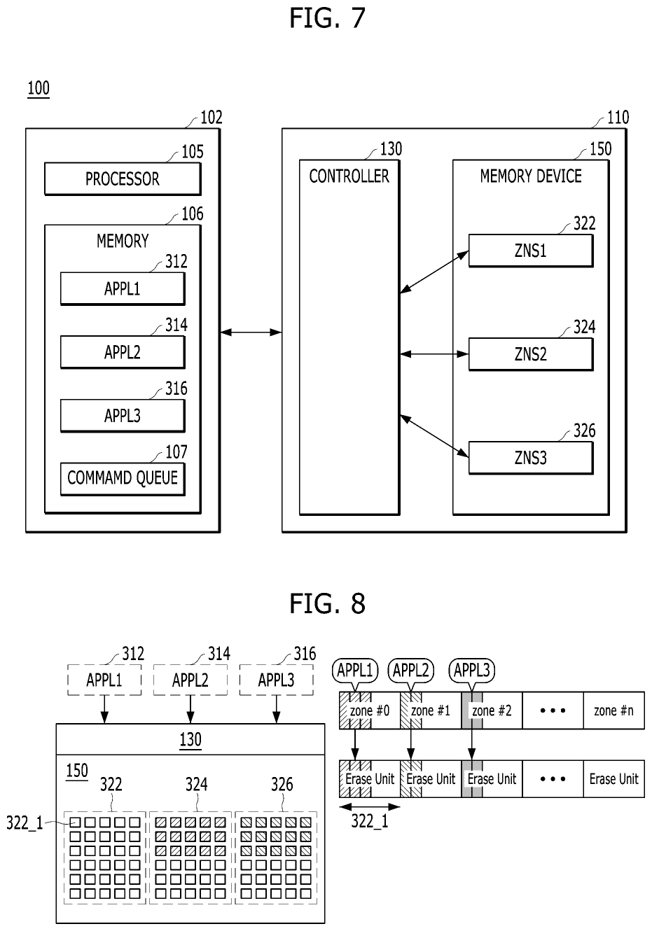

FIG. 7 is a diagram illustrating a data processing system in accordance with an embodiment of the present disclosure in which Zoned Namespace technology is implemented. Referring to FIG. 7, a data processing system 100 includes a host 102 and a memory system 110. Since components included in the host 102 and the memory system 110 are the same as those described above, description thereof will be omitted herein.

At least some of the plurality of memory blocks included in the memory device 150 may be allocated as Namespaces (hereinafter, referred to as Zoned Namespaces (ZNS)) which are divided into the units of zones.

The Zoned Namespaces (ZNS) refer to the use of namespaces which are divided into the units of zones. The namespace may mean an amount (storage space) of a nonvolatile memory which may be formatted as a logical block. In a memory system to which the Zoned Namespace technology is applied, a data input/output operation may be performed differently from that of a general nonvolatile memory system.

For example, as illustrated in the drawing, a plurality of applications APPL1, APPL2 and APPL3 are being executed in the host 102 and the plurality of applications APPL1, APPL2 and APPL3 loaded in the memory 106 generate data and store the generated data in the memory system 110. The memory 106 may include a command queue 107 which queues a command to be processed by the processor 105. The command queue 107 may include a command which controls the memory device 150. For example, the command queue 107 may include commands such as read, program, erase, and status checking commands.

A general nonvolatile memory system sequentially stores data, inputted from the host 102 which is coupled to the memory system, in the memory device 150. The data generated by the plurality of applications APPL1, APPL2 and APPL3 may be stored without distinction in the memory device 150 according to the order in which the data are transferred from the host 102 to the memory system 110. The data generated by the plurality of applications APPL1, APPL2 and APPL3 may be mixedly stored in an open memory block for programming data. In this process, the controller 130 generates map data capable of linking a logical address inputted from the host 102 and a physical address indicating a location where data is stored in the memory device 150. Thereafter, when the plurality of applications APPL1, APPL2 and APPL3 of the host 102 request the data stored in the memory system 110, the controller 130 may output the data, requested by the plurality of applications APPL1, APPL2 and APPL3, to the host on the basis of the map data.

In the general nonvolatile memory system, various types of data or data generated by various applications may be mixedly stored in one memory block. In this case, validities (recentness) of the data stored in the memory block may be different from one another and may be difficult to predict. Due to this fact, when garbage collection is performed, a lot of resources may be consumed in identifying valid data or checking whether data is valid. Also, since there may be a plurality of applications which are associated with one memory block, when garbage collection is performed on the corresponding memory block, data input/output operations requested by the plurality of corresponding applications may be delayed. However, the Zoned Namespace (ZNS) technology may solve the problems in the general nonvolatile memory system described above.

In the Zoned Namespace (ZNS) technology, the plurality of applications APPL1, APPL2 and APPL3 executed in the host 102 may sequentially store data in zones respectively designated thereto. Each zone may include a predetermined space in a logical address system used by the host 102 and some of the plurality of memory blocks included in the memory device 150. Referring to FIG. 7, the memory device 150 may include a plurality of Zoned Namespaces (ZNS1, ZNS2 and ZNS3) 322, 324 and 326 corresponding to a plurality of applications (APPL1, APPL2 and APPL3) 312, 314 and 316. A first application (APPL1) 312 may store data in a first Zoned Namespace (ZNS1) 322, a second application (APPL2) 314 may store data in a second Zoned Namespace (ZNS2) 324, and a third application (APPL3) 316 may store data in a third Zoned Namespace (ZNS3) 326. In this case, since data generated by the first application APPL1 are sequentially stored in memory blocks included in the first Zoned Namespace ZNS1, it is not necessary to check memory blocks included in the other Zoned Namespaces ZNS2 and ZNS3 to check valid data. In addition, until the first Zoned Namespace ZNS1 allocated to the first application APPL1 is short of storage space, it is not necessary to perform garbage collection on the memory blocks allocated to the first Zoned Namespace ZNS1. For this reason, the efficiency of garbage collection for the memory device 150 may be increased, and the frequency of garbage collection for the memory device 150 may be decreased. This may result in a decrease in a write amplification factor (WAF) indicating a degree to which the amount of write in the memory device 150 is amplified, and may increase the lifespan of the memory device 150. In the memory system 110 to which the Zoned Namespace (ZNS) technology is applied, media over-provisioning may be reduced in the memory device 150, and the usage rate of the volatile memory 144 (see FIG. 1) may be decreased.

Also, as the amount of data processing and the amount of data transmission/reception are reduced, it is possible to reduce overhead occurring in the memory system 110. Through this, the performance of the data input/output operation of the memory system 110 may be improved.

According to an embodiment, the plurality of applications APPL1, APPL2 and APPL3 executed in the host 102 may be allocated with different Zoned Namespaces (ZNS), respectively. In another embodiment, the plurality of respective applications APPL1, APPL2 and APPL3 executed in the host 102 may use together a specific Zoned Namespace (ZNS). In still another embodiment, each of the plurality of applications APPL1, APPL2 and APPL3 executed in the host 102 may be allocated with a plurality of Zoned Namespaces (ZNS), and thereby, may use the plurality of allocated Zoned Namespaces (ZNS) corresponding to the characteristics of data to be stored in the memory system 110. For example, when the first application APPL1 is allocated with the first Zoned Namespace ZNS1 and the second Zoned Namespace ZNS2, the first application APPL1 may store hot data (e.g., data to which access occurs frequently or whose validity period (update period) is short) in the first Zoned Namespace ZNS1, and may store cold data (e.g., data to which access occurs infrequently or whose validity period (update period) is long) in the second Zoned Namespace ZNS2.

According to an embodiment, the controller 130 may equally allocate all the memory blocks included in the memory device 150 to a plurality of Zoned Namespaces. In this case, the plurality of memory blocks allocated to the Zoned Namespaces may include a memory block which stores data and a free memory block which stores no data.

Furthermore, according to an embodiment, the controller 130 may allocate only some, among all the memory blocks included in the memory device 150, corresponding to a storage space required by each Zoned Namespace. When allocation of memory blocks is released according to garbage collection, some of the memory blocks included in the memory device 150 may be maintained in a state in which they are not allocated to any Zoned Namespace. If necessary, the controller 130 may additionally allocate an unallocated memory block to a Zoned Namespace according to a request of an external device or in the process of performing an input/output operation.

FIG. 8 is a diagram illustrating a memory system including a nonvolatile memory device which supports Namespaces divided into the units of zones in accordance with an embodiment of the present disclosure.

Referring to FIG. 8, the plurality of applications 312, 314 and 316 executed in the host 102 (see FIG. 1) may request the controller 130 to perform a data input/output operation using Zoned Namespaces (ZNS). According to a request from the host 102 for a memory allocation according to Zoned Namespaces, the controller 130 may allocate the plurality of memory blocks, included in the memory device 150, to the three Zoned Namespaces 322, 324 and 326 in such a manner that a zone identified in each Zoned Namespace corresponds to the erase unit of the memory device 150.

A Zoned Namespace may include one or a plurality of zones.

Each zone identified by the host 102 may correspond to each erase unit of the memory device 150, and the erase unit may be the super block of FIG. 6.

For example, describing a memory block 322_1 which is allocated to the first Zoned Namespace 322, the memory block 322_1 may be the erase unit, and may correspond to a first zone zone #0 of the first Zoned Namespace 322. The first application (APPL1) 312 may use the first zone zone #0 of the first Zoned Namespace 322, and data associated with the first application (APPL1) 312 may be sequentially stored in the first zone zone #0. By dividing a Zoned Namespace into a plurality of zones and sequentially storing data in each of the plurality of zones, it is possible to use the memory device 150 faster and more efficiently, and reduce the difference between the logical address system used by the host 102 and a physical address system in the memory device 150. The first application (APPL1) 312 may allocate a logical address of the first zone zone #0, set in the first Zoned Namespace 322, to generate data in the logical address system. Such data may be sequentially stored in the memory block 322_1 which is allocated to the first application (APPL1) 312.

The plurality of applications 312, 314 and 316 may use respective zones zone #0, zone #1, zone #2, . . . and zone #n allocated thereto. As described above with reference to FIG. 7, according to an embodiment, a plurality of zones may be allocated to one application, or a plurality of applications may share one zone. Also, in each of the Zoned Namespaces 322, 324 and 326, zones requested by the plurality of applications 312, 314 and 316 in the logical address system may be allocated in advance. Each of the plurality of applications 312, 314 and 316 may not use the zones zone #0, zone #1, zone #2, . . . and zone #n which are not allocated thereto. Namely, a logical address which is allocated in advance to a specific zone may not be used by another application which uses another zone. Through this, it is possible to prevent data, generated by various applications, from being mixedly stored in a memory block in a conventional nonvolatile memory device.

When the Zoned Namespace technology is used, a logical address and a physical address may be sequentially allocated to data, generated by an application, in the logical address system and the physical address system, and garbage collection may be performed by the unit of zone, whereby it is possible to easily perform garbage collection. According to an embodiment, the host 102 may change storage spaces allocated to the zones zone #0, zone #1, zone #2, . . . and zone #n, and may additionally allocate a memory block which is not allocated to the Zoned Namespaces 322, 324 and 326 in the memory device 150.

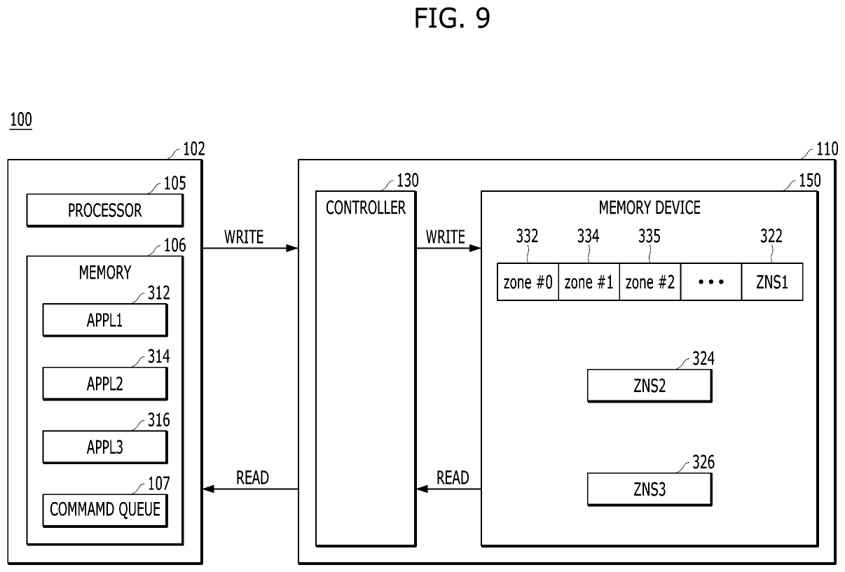

FIG. 9 is a diagram illustrating a method for a host to perform garbage collection using Zoned Namespaces in accordance with an embodiment of the present disclosure. As described above, the host 102 may perform garbage collection by the unit of zone. Referring to FIG. 9, data corresponding to the first application (APPL1) 312 is allocated to a first zone 332 of the first Zoned Namespace 322, data corresponding to the second application (APPL2) 314 is allocated to a second zone 334 of the first Zoned Namespace 322, and data is not allocated yet to a third zone 335 of the first Zoned Namespace 322.

When the host 102 performs garbage collection using Zoned Namespaces, garbage collection may be performed by the unit of zone. For example, the first zone 332 may be selected as a victim zone and valid data to be moved from the victim zone 332 to a target zone may be selected. When the third zone 335 is selected as a target zone to which data is to be moved to from the victim zone, the controller 130 may read the data from the first zone 332, store the read data in the memory 144 and then transmit the stored data to the host 102, and the host 102 may store the transmitted data in the memory 106.

The host 102 which receives the data to be moved to the target zone may transmit, to the controller 130, a write command and the data to be moved to the target zone and may also transmit information on the third zone 335 or the target zone to which the data is to be moved. The controller 130 which receives the data to be moved to the target zone may store the received data in the memory 144, may program the data in the third zone 335 or the target zone, may erase the data stored in the first zone 332, and thereby, may select the first zone 332 as a free zone.

In the case of the host-based garbage collection performed by the host 102 as described above, since the data is transmitted to the host 102 and is then transmitted to the memory system 110 from the host 102, a data transmission time is required. Also, when the host 102 is performing another operation, a time allocable to garbage collection decreases, and thus, a lot of time may be required to perform garbage collection.

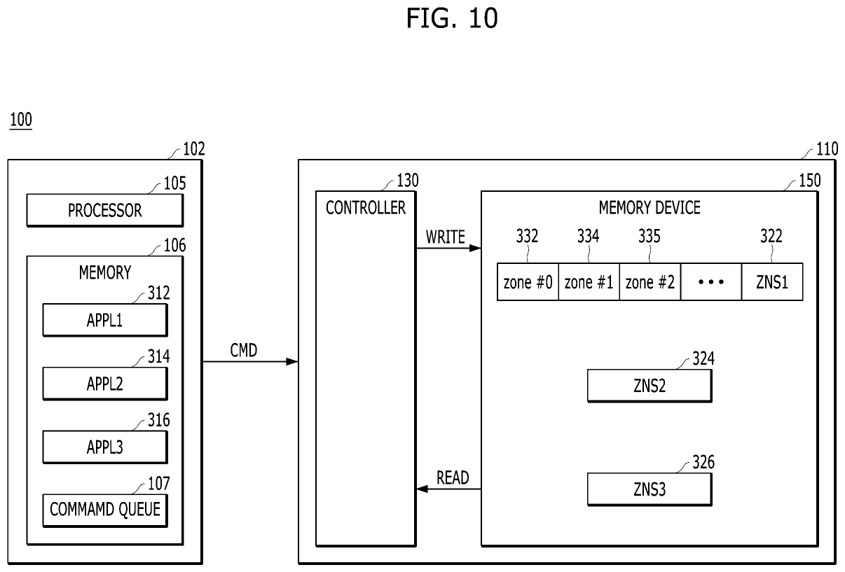

FIG. 10 is a diagram illustrating a garbage collection method in the data processing system 100 in accordance with the embodiment of the present disclosure to which the Zoned Namespace technology is applied.

When the host 102 is performing another operation, less time may be allocated to garbage collection, and thus, the host 102 may first determine whether it is possible to perform garbage collection. In order to determine the load of the host 102, the host 102 may check the number of commands for controlling the memory system 110, the commands being queued in the command queue 107, or may compare an occupation time amount and an input/output (IO)) standby time amount, and thereby, may decide whether to perform host-based garbage collection by the host 102 or whether to request the garbage collection to the memory system 110. The occupation time amount is a time amount for which a process of the host 102 occupies the processor 105. The IO standby time amount is a time amount for which the host 102 stands by for input/output to/from the memory system 110.

For example, when the number of commands for controlling the memory system 110, such as read, program, and erase commands queued in the command queue 107 exceeds a threshold, the host 102 may determine that it is unsuitable for the memory system 110 to perform garbage collection and may decide that the host 102 performs garbage collection by itself. When the number of commands for controlling the memory system 110 is equal to or less than the threshold, the host 102 may decide that the memory system 110 instead of the host 102 should perform garbage collection. According to an embodiment of the present disclosure, the host 102 may compare, at a predetermined time interval, the occupation time amount and the IO standby time amount. When the difference between the occupation time amount and the IO standby time amount exceeds a threshold, the host 102 may not perform garbage collection and may request garbage collection to the memory system 110.

When the host 102 decides not to perform garbage collection, the host 102 may select a victim zone and a target zone. Taking the case described above with reference to FIG. 9 again as an example, the host 102 may select the first zone 332 of the first Zoned Namespace 322 as a victim zone, and may select the third zone 335 as a target zone.

The host 102 may collect information on the logical block address of valid data to be moved from the victim zone 332 to the target zone 335, and may transmit, to the memory system 110, a garbage collection request including information on the victim zone 332 and the target zone 335 and the information on the logical block address of the valid data as the target of garbage collection.

The memory system 110 may receive the garbage collection request, may collect the valid data from the victim zone 332 by using the information on the logical block address of the valid data, may move the corresponding data to the target zone 335, may erase data of the victim zone 332, and then, may notify the host 102 of the completion of the garbage collection request. Since the valid data as the target of garbage collection is sequentially moved to the target zone 335 and an address is calculated by the host 102, the completion notification may not include information other than the completion report of garbage collection.

According to the method described above with reference to FIG. 10, the host 102 may decide whether the host 102 will directly perform garbage collection or the memory system 110 will perform garbage collection, by determining the load of the host 102. When the load of the host 102 is large, the host 102 may request the memory system 110 to perform garbage collection, thereby reducing a time required for garbage collection. In addition, since the memory system 110 does not transmit the data as the target of garbage collection to the host 102, a time required for data transmission may also be reduced.

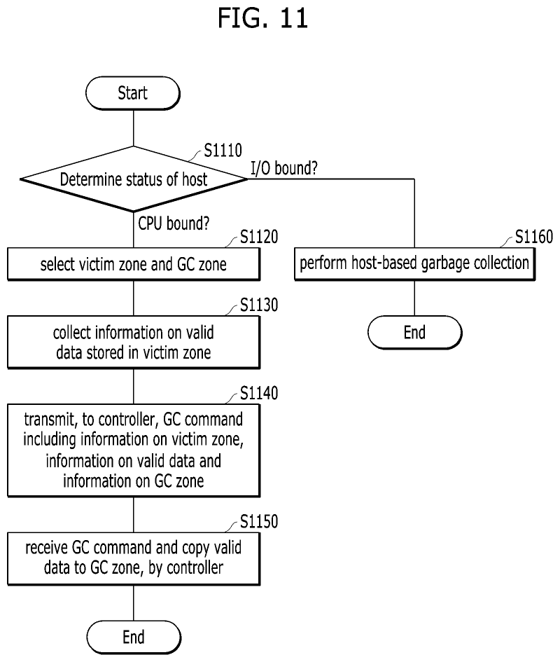

FIG. 11 is a flowchart illustrating the garbage collection method in the data processing system 100 in accordance with an embodiment of the present disclosure to which the Zoned Namespace technology is applied. Referring to FIG. 11, at operation S1110, the host 102 may determine a status of the host 102 in order to secure a free zone in a Zoned Namespace. Since the host 102 may have no or insufficient free zone or may be in a situation in which it is necessary to secure a free zone in advance, the host 102 may decide whether the host 102 will directly perform garbage collection or will request garbage collection to the memory system 110, depending on the status of the host 102. The host 102 may decide whether the current status of the host 102 is a processor-bound status or an input/output (IO)-bound status, and may perform garbage collection according to a decision result. The processor-bound status refers to a status in which the host 102 allocates more resources for a process of the processor 105 more than input/output to/from the memory system 110 and occupies the processor 105 for more of a time amount than input/output to/from the memory system 110. The IO-bound status refers to a status in which the host 102 allocates more resource for input/output to/from the memory system 110 more than a process of the processor 105 and occupies more of a time amount for the input/output to/from the memory system 110 than the process of the processor 105.

When it is determined that the status of the host 102 is the processor-bound status, the host 102 may proceed to operation S1120, and when it is determined that the status of the host 102 is the IO-bound status, the host 102 may proceed to operation S1160. In an embodiment, the host 102 may determine the processor-bound status by the number of commands queued in the command queue 107. For example, when the number of commands for controlling the memory system 110, included in the command queue 107, exceeds a threshold, the host 102 may determine that the status of the host 102 is the IO-bound status. In another embodiment, the host 102 may determine the processor-bound status by comparing the occupation time amount and the IO standby time amount. That is, the host 102 may determine the status of the host 102 as the processor-bound status when the difference between the occupation time amount and the IO standby time amount exceeds a preset threshold, and may determine the status of the host 102 as the IO-bound status when the difference does not exceed the preset threshold.

At the operation S1120, the host 102 may select a victim zone for garbage collection and a target zone to which data is to be moved from the victim zone. The victim zone may mean a zone which stores valid data on which garbage collection is to be performed, and the target zone may mean a zone to which the valid data is to be moved from the victim zone.

At operation S1130, the host 102 may collect information on the valid data stored in the victim zone. In an embodiment, the information on the valid data may be a logical block address (LBA).

At operation S1140, the host 102 may transmit, to the controller 130, a garbage collection request including information on the victim zone, the information on the valid data as a garbage collection target and information on the target zone to which the valid data is to be moved, and may request the controller 130 to perform garbage collection. That is, the host 102 may reduce the load of the processor 105 of the host 102 by requesting garbage collection to the memory system 110.

At operation S1150, the controller 130 may receive the garbage collection request from the host 102, and may move the valid data to the target zone by using the information on the victim zone, the information on the valid data and the information on the target zone included in the garbage collection request. When the execution of the garbage collection request is completed, the controller 130 may notify the host 102 of the completion of garbage collection.

When the host 102 determines at the operation S1110 that the status of the host 102 is the IO-bound status, at the operation S1160, the host 102 may perform host-based garbage collection which is to be performed by the host 102 of FIG. 10.

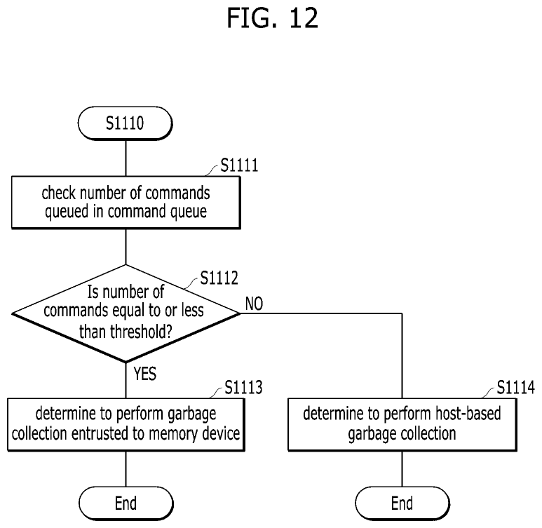

FIG. 12 is a flowchart illustrating a method for deciding a subject for performing garbage collection in accordance with an embodiment of the present disclosure, and is a diagram showing in detail the operation S1110 of FIG. 11.

Referring to FIG. 12, at operation S1111, the host 102 may check the number of commands for controlling the memory system 110, which are queued in the command queue 107.

At operation S1112, the host 102 may determine whether the number of commands checked at the operation S1111 is equal to or less than the threshold. When the number of commands is equal to or less than the threshold (YES of the operation S1112), the host 102 may request the garbage collection to the memory system 110 (operation S1113).

When the checked number of commands exceeds the threshold (NO of the operation S1112), the host 102 may decide to perform host-based garbage collection (operation S1114).

Although not shown in the present flowchart, according to an embodiment of the present disclosure, the host 102 may check, at the operation S1111, the number of commands other than commands for controlling the memory system 110 queued in the command queue 107, and at the operation S1112, the host 102 may determine whether the number of commands checked at the operation S1111 is equal to or less than a threshold and may decide to perform host-based garbage collection when the number of commands is equal to or less than the threshold. When the checked number of commands exceeds the threshold, the host 102 may decide to request garbage collection to the memory device 150.

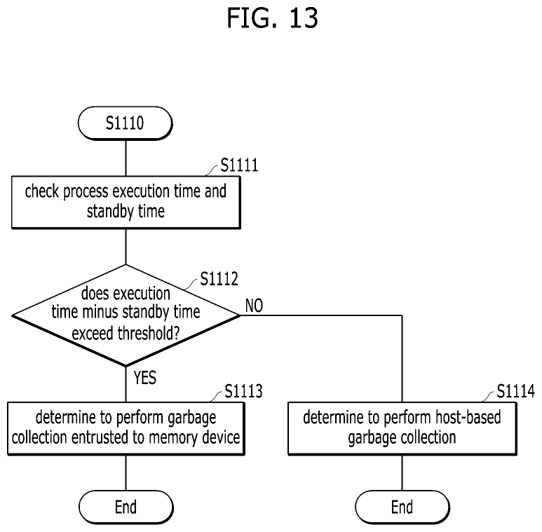

FIG. 13 is a flowchart illustrating a method for deciding a subject for performing garbage collection in accordance with an embodiment of the present disclosure. Similarly to FIG. 12, FIG. 13 is a diagram showing in detail the operation S1110 of FIG. 11.

Referring to FIG. 13, at operation S1111, the host 102 may check the occupation time amount and the IO standby time amount. When a value obtained by subtracting the IO standby time amount from the occupation time amount exceeds a threshold (YES of operation S1112), the host 102 may request the garbage collection to the memory system 110 (operation S1113), and when the value is equal to or less than the threshold (NO of the operation S1112), the host 102 may decide to perform host-based garbage collection and may directly perform garbage collection (operation S1114).

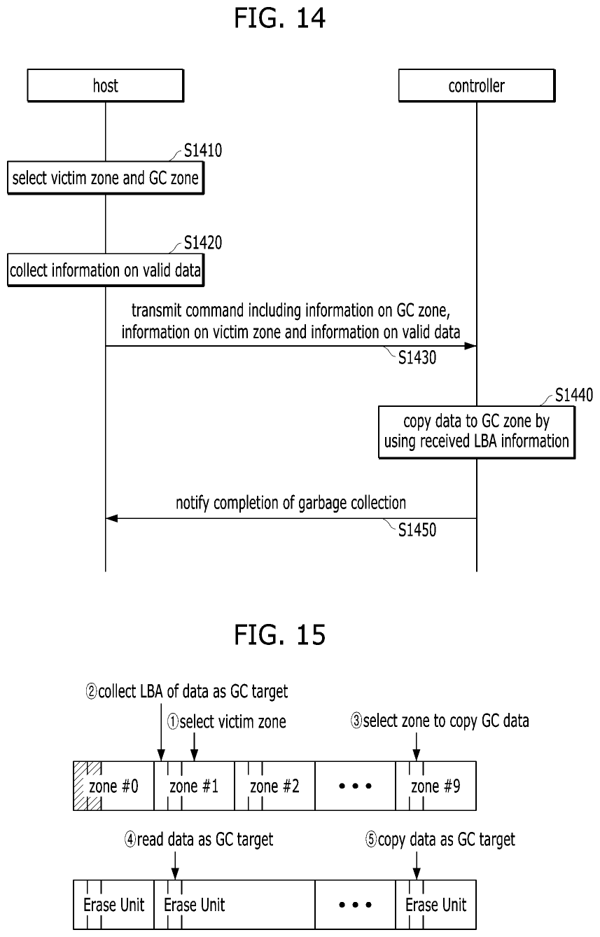

FIG. 14 is a flow diagram illustrating a process in accordance with an embodiment of the present disclosure in which the host 102 transmits a garbage collection request to the controller 130 of the memory system 110.

At operation S1410, the host 102 may select a victim zone for garbage collection and a target zone as a zone to which valid data being a garbage collection target is to be moved, and at operation S1420, the host 102 may collect information on the valid data being the garbage collection target, which is stored in the victim zone. In an embodiment, the information on the valid data may be a logical block address.

When the information on the valid data is collected, the host 102 may transmit information on the target zone as a location where garbage collection data is to be moved, information on the victim zone and the information on the valid data to the controller 130, and may transmit a garbage collection request which instructs garbage collection to be performed using the transmitted information (operation S1430).

The controller 130, which receives the garbage collection request and the information on the victim zone, the information on the target zone and the information on the valid data accompanying the garbage collection request, may read the valid data in the victim zone by using the information on the victim zone and the information on the valid data, and then, may move the read valid data to the target zone (operation S1440). For example, the controller 130 may read the data of the victim zone using information on a logical block address (LBA), which is transmitted from the host 102, and may move the read data to the target zone.

When the garbage collection operation is completed, the controller 130 may notify the host 102 that garbage collection is completed (operation S1450).

FIG. 15 is a diagram illustrating an example of a process of performing garbage collection requested to the memory system 110 in accordance with an embodiment of the present disclosure. Referring to FIG. 15, the host 102 may decide a second zone zone #1 as a victim zone, may select valid data to be moved from the victim zone, and may collect a logical block address (LBA) for the valid data. The host 102 may decide a tenth zone zone #9 as a target zone to which the valid data is to be moved, and may transfer a garbage collection request including information on the victim zone, the target zone and the valid data to the memory system 110.

The controller 130, which receives the garbage collection request, may read the valid data as a garbage collection target in an erase unit corresponding to the second zone zone #1 decided as the victim zone, by using the information on the victim zone, the target zone and the valid data received from the host 102, and may move the valid data read in the erase unit corresponding to the tenth zone zone #9 as the target zone.

Although various embodiments have been described for illustrative purposes, it will be apparent to those skilled in the art that various changes and modifications may be made without departing from the spirit and scope of the disclosure as defined in the following claims. Furthermore, the embodiments may be combined to form additional embodiments.

What is claimed is:

1. A data processing system comprising:
a host including a processor and a volatile memory and configured to sequentially allocate data to a plurality of zones of a Zoned Namespace; and
a memory system including:
a memory device including a plurality of memory blocks; and
a controller configured to allocate the plurality of memory blocks to respective zones of the Zoned Namespace and access a memory block allocated for one of the plurality of zones according to an address of the zone inputted together with a data input/output request from the host,
wherein the host is further configured to request garbage collection to the controller or perform host-based garbage collection, depending on a load level of the host.

2. The data processing system according to claim 1, wherein the host is further configured to determine the load level based on a number of memory system control commands or an occupation time amount for which a process of the host occupies the processor.

3. The data processing system according to claim 2,
wherein the volatile memory includes a command queue, and
wherein the host requests garbage collection to the controller when the number of memory system control commands included in the command queue is equal to or less than a threshold and performs the host-based garbage collection when the number of memory system control commands exceeds the threshold.

4. The data processing system according to claim 2,
wherein the host is further configured to compare the occupation time amount with an input/output (IO) standby time amount of the processor for the memory system, and
wherein the host requests the garbage collection to the controller when a difference between the occupation time amount and the TO standby time amount exceeds a threshold and performs the host-based garbage collection when the difference is equal to or less than the threshold.

5. The data processing system according to claim 1, wherein the host requests the garbage collection to the controller by providing the controller with information on a victim zone, a target zone and valid data to be moved from the victim zone to the target zone.

6. The data processing system according to claim 5, wherein in response to the request, the controller is further configured to perform a garbage collection operation on the victim and target zones for the valid data according to the information.

7. The data processing system according to claim 6, wherein a memory block allocated to correspond to the victim zone is configured in an erase unit.

8. The data processing system according to claim 7, wherein the erase unit is a super block.

9. The data processing system according to claim 7, wherein the Zoned Namespace includes a plurality of zones, the plurality of zones correspond to a plurality of erase units and include the victim zone and the target zone, and the controller performs garbage collection for an erase unit corresponding to the victim zone and the target zone.

10. A method for operating a data processing system, comprising:
sequentially allocating, by a host including a processor and a volatile memory, data to a plurality of zones of a Zoned Namespace;
allocating, by a controller, a plurality of memory blocks of a memory device to respective zones of the Zoned Namespace;
accessing, by the controller, a memory block allocated for one zone among the plurality of zones according to an address of the zone inputted together with a data input/output request from the host; and
requesting, by the host, garbage collection to the controller or performing host-based garbage collection, depending on a load level of the host.

11. The method according to claim 10, further comprising determining, by the host, the load level based on a number of memory system control commands or an occupation time amount for which a process of the host occupies the processor.

12. The method according to claim 11,
wherein the garbage collection is requested to the controller when the number of memory system control commands included in a command queue within the host is equal to or less than a threshold, and
wherein the host-based garbage collection is performed when the number of memory system control commands exceeds the threshold.

13. The method according to claim 11,
further comprising comparing, by the host, the occupation time amount with an input/output (TO) standby time amount of the processor for the memory system,
wherein the garbage collection is requested to the controller when a difference between the occupation time amount and the TO standby time amount exceeds a threshold, and
wherein the host-based garbage collection is performed when the difference is equal to or less than the threshold.

14. The method according to claim 10, wherein the request of the garbage collection includes providing the controller with information on a victim zone, a target zone, and valid data to be moved from the victim zone to the target zone.

15. The method according to claim 14, further comprising performing, by the controller in response to the request, a garbage collection operation on the victim zone and the target zone for the valid data according to the information.

16. The method according to claim 15, wherein a memory block allocated to correspond to the victim zone is configured in an erase unit.

17. The method according to claim 16, wherein the erase unit is a super block.

18. The method according to claim 16, wherein the Zoned Namespace includes a plurality of zones, the plurality of zones correspond to a plurality of erase units and include the victim zone and the target zone, and the controller performs garbage collection for an erase unit corresponding to the victim zone and the target zone.

19. A memory system comprising:
a memory device including a plurality of memory blocks; and
a controller configured to:
allocate the plurality of memory blocks to respective zones of a Zoned Namespace,
access a memory block allocated for one of the plurality of zones according to an address of the zone inputted together with a data input/output request, and
perform a garbage collection operation in response to a garbage collection request from a host.

20. The memory system according to claim 19,
wherein the request includes information on a victim zone, a target zone, and valid data to be moved from the victim zone to the target zone, and
wherein the controller is further configured to perform, in response to the request, a garbage collection operation on the victim zone and the target zone for the valid data according to the information.
